(19) United States
(12) Patent Application Publication
(10) Pub. No.: US 2014/0303950 A1
(43) Pub. Date: Oct. 9, 2014

(54) UNIDIRECTIONAL BRANCH EXTENT IN A FLOW NETWORK

(71) Applicant: Schlumberger Technology Corporation, Sugar Land, TX (US)

(72) Inventors: Fabien Houeto, Sugar Land, TX (US); Bobby Kiehn, Houston, TX (US)

(73) Assignee: Schlumberger Technology Corporation, Sugar Land, TX (US)

(21) Appl. No.: 14/246,640

(22) Filed: Apr. 7, 2014

Related U.S. Application Data
(60) Provisional application No. 61/810,069, filed on Apr. 9, 2013.

(51) Int. Cl. G06F 17/50

(52) U.S. Cl. CPC G06F 17/509
USPC 703/10

(57) ABSTRACT

A method can include receiving a model of a network of a production system that includes information that specifies branches and pieces of equipment; processing, optionally in parallel, at least a portion of the information for at least a portion of the model of the network; and, based at least in part on the processing, assigning a flow direction to each of the branches in the at least a portion of the model of the network. Various other technologies, techniques, etc., are also disclosed.

### RELATED APPLICATIONS

This applications claims priority to and the benefit of a U.S. Provisional Patent Application having Ser. No. 61/810,069, filed 9 Apr. 2013, which is incorporated herein by reference.

### BACKGROUND

Production systems can provide for transportation of oil and gas fluids from well locations to processing facilities and represent a substantial investment in infrastructure with both economic and environmental impact. Simulation of such systems, which may include hundreds or thousands of flowlines and production equipment interconnected at junctions to form a network, can be a formidable task.

### SUMMARY

A method can include receiving a model of a network of a production system that includes information that specifies branches and pieces of equipment; processing, optionally in parallel, at least a portion of the information for at least a portion of the model of the network; and, based at least in part on the processing, assigning a flow direction to each of the branches in the at least a portion of the model of the network. A system can include a processor; memory accessible by the processor; one or more modules stored in the memory where the one or more modules include processor-executable instructions to instruct the system to receive a model of a network of a production system that includes information that specifies branches and pieces of equipment; process, optionally in parallel, at least a portion of the information for at least a portion of the model of the network; and, based at least in part on the process, assign a flow direction to each of the branches in the at least a portion of the model of the network. One or more computer-readable storage media can include computer-executable instructions executable by a computer to instruct the computer to: process, optionally in parallel, at least a portion of information that specifies branches and pieces of equipment for at least a portion of a model of a network; and, based at least in part on the process, assign a flow direction to each of the branches in the at least a portion of the model of the network. Various other technologies, techniques, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example field system that includes various components, an example of a method and an example of a device or system;

FIG. 2 illustrates an example of a system;

FIG. 3 illustrates an example of a system;

FIG. 4 illustrates an example of a network and an example of a system;

FIG. 5 illustrates an example of a network;

FIG. 6 illustrates an example of a network;

FIG. 7 illustrates an example of components in a network;

FIG. 8 illustrates an example of a method;

FIG. 9 illustrates an example of a method;

FIG. 10 illustrates an example of a system, examples of modules and an example of a process; and

FIG. 11 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

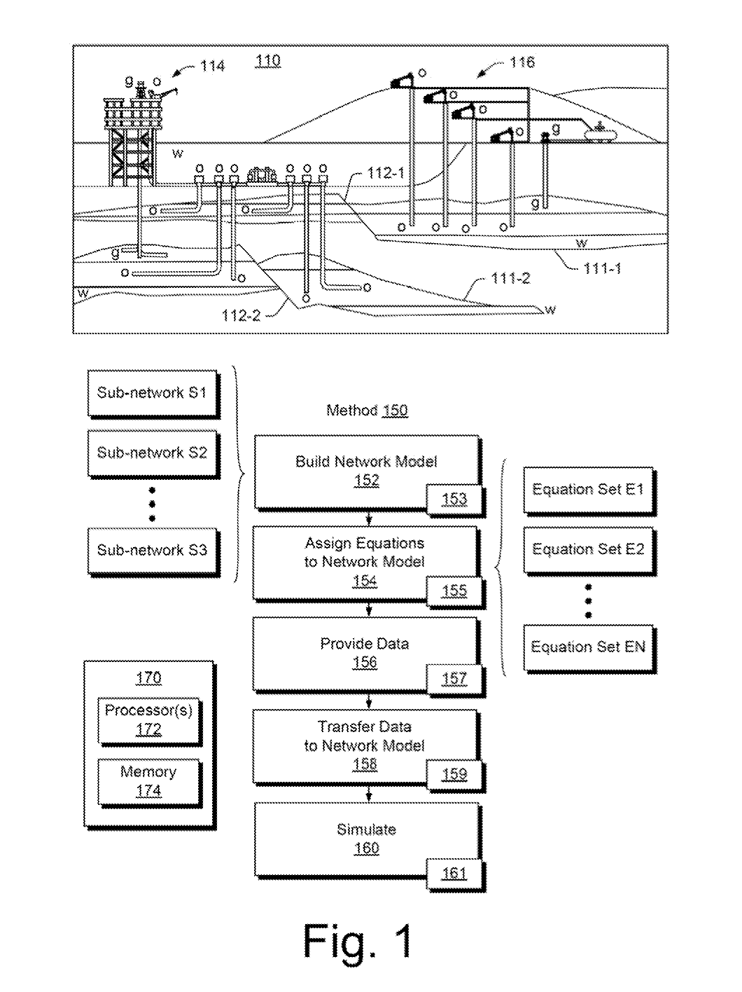

FIG. 1 shows an example of a geologic environment 110 that includes reservoirs 111-1 and 111-2, which may be faulted by faults 112-1 and 112-2, an example of a method 150 and an example of a device or system 170. FIG. 1 also shows some examples of offshore equipment 114 for oil and gas operations related to the reservoirs 111-1 and 111-2 and onshore equipment 116 for oil and gas operations related to the reservoir 111-1.

As an example, a model may be made that models a geologic environment in combination with equipment, wells, etc. For example, a model may be a flow simulation model for use by a simulator to simulate flow in an oil, gas or oil and gas production system. Such a flow simulation model may include equations, for example, to model multiphase flow from a reservoir to a wellhead, from a wellhead to a reservoir, etc. A flow simulation model may also include equations that account for flowline and surface facility performance, for example, to perform a comprehensive production system analysis.

As an example, a flow simulation model may be a network model (e.g., a model of a network) that includes various sub-networks specified using nodes, segments, branches, etc. As an example, a flow simulation model may be specified in a manner that provides for modeling of branched segments, multilateral segments, complex completions, intelligent downhole controls, etc.

As an example, a system may provide for transportation of oil and gas fluids from well locations to processing facilities and may represent a substantial investment in infrastructure with both economic and environmental impact. Simulation of such a system, which may include hundreds or thousands of flow lines and production equipment interconnected at junctions to form a network, can involve multiphase flow science and, for example, use of engineering and mathematical techniques for large systems of equations.

As an example, a flow simulation model may include equations for performing nodal analysis, pressure-volume-temperature (PVT) analysis, gas lift analysis, erosion analysis, corrosion analysis, production analysis, injection analysis, etc. In such an example, one or more analyses may be based, in part, on a simulation of flow in a modeled network.

As to nodal analysis, it may provide for evaluation of well performance, for making decisions as to completions, etc. A nodal analysis may provide for an understanding of behavior of a system and optionally sensitivity of a system (e.g., production, injection, production and injection). For example, a system variable may be selected for investigation and a sensitivity analysis performed. Such an analysis may include plotting inflow and outflow of fluid at a nodal point or nodal points in the system, which may indicate where certain opportunities exist (e.g., for injection, for production, etc.).

A modeling framework may include modules to facilitate generation of a flow simulation model. For example, a module may provide for modeling completions for vertical wells, completions for horizontal wells, completions for fractured wells, etc. A modeling framework may include modules for particular types of equations, for example, black-oil equations, equation-of-state (EOS) equations, etc. A modeling framework may include modules for artificial lift, for example, to model fluid injection, fluid pumping, etc. As an example, consider a module that includes features for modeling one or more electric submersible pumps (ESPs) (e.g., based in part on pump performance curves, motors, cables, etc.).

As an example, an analysis using a flow simulation model may be a network analysis to: identify production bottlenecks and constraints; assess benefits of new wells, additional pipelines, compression systems, etc.; calculate deliverability from field gathering systems; predict pressure and temperature profiles through flow paths; or plan full-field development.

As an example, a flow simulation model may provide for analyses with respect to future times, for example, to allow for optimization of production equipment, injection equipment, etc. As an example, consider an optimal time-based and conditional-event logic representation for daily field development operations that can be used to evaluate drilling of new developmental wells, installing additional processing facilities over time, choke-adjusted wells to meet production and operating limits, shutting in of depleting wells as reservoir conditions decline, etc.

As to equations, a flow simulation model may include one or more sets of equations for three-phase mechanistic multiphase flow (e.g., according to one or more of a LedaFlow™ point model (Kongsberg Oil & Gas Technologies AS, Sandvika, Norway), OLGA-S™ model (Schlumberger Ltd, Houston, Tex.), TUFFP unified mechanistic models (Tulsa University Fluid Flow Projects, Tulsa, Okla.), etc.).

As to the method 150 of FIG. 1, it can include a build block 152 for building a network model that represents a production system for fluid; an assignment block 154 for assigning equations to sub-networks in the network model (e.g., where at least one of the sub-networks is optionally assigned equations formulated for solving for enthalpy implicitly or temperature implicitly), a provision block 156 for providing data; a transfer block 158 for transferring the data to the network model; and a simulation block 160 for simulating physical phenomena associated with the production system using the network model to provide simulation results.

The method 150 is shown in FIG. 1 in association with various computer-readable media (CRM) blocks 153, 155, 157, 159 and 161. Such blocks generally include instructions suitable for execution by one or more processors (or processing cores) 172 to instruct the computing device or system 170 to perform one or more actions. While various blocks are shown, a single medium may be configured with instructions to allow for, at least in part, performance of various actions of the method 150. As an example, a computer-readable medium (CRM) may be a computer-readable storage medium, for example, such as a memory device 174 of the computing device or system 170, where the memory device 174 includes memory.

A production system can include equipment, for example, where a piece of equipment of the production system may be represented in a sub-network of a network model and, for example, assigned equations formulated to represent the piece of equipment as non-adiabatic (e.g., or adiabatic). As an example, a piece of equipment may include an electric motor operatively coupled to a mechanism to move fluid (e.g., a pump, compressor, etc.). As an example, a piece of equipment may include a heater coupled to a power source, a fuel source, etc. (e.g., consider a steam generator). As an example, a piece of equipment may include a conduit for delivery of fluid where the fluid may be for delivery of heat energy (e.g., consider a steam injector). As an example, a piece of equipment may include a conduit for delivery of a substance (e.g., a chemical, a proppant, etc.).

As an example, a sub-network may be assigned equations formulated for solving for enthalpy implicitly or temperature implicitly to represent fluid at or near a critical point, to represent heavy oil, to represent steam, to represent water or one or more other fluids (e.g., optionally subject to certain physical phenomena such as pressure, temperature, etc.).

As an example, a system can include a processor; a memory device having memory accessible by the processor; and one or more modules that include processor-executable instructions stored in the memory of the memory device, the instructions executable to instruct the system to: build a network model that represents a production system for fluid, assign equations to sub-networks in the network model, provide data, transfer the data to the network model, and simulate physical phenomena associated with the production system using the network model to provide simulation results.

As an example, a system can include a sub-network assigned equations formulated for steam associated with equipment for an enhanced oil recovery (EOR) process (e.g., steam-assisted gravity drainage (SAGD) and/or other EOR process).

As an example, a system can include a sub-network that represents a piece of equipment of a production system by assigning that sub-network equations formulated to represent the piece of equipment. In such an example, the piece of equipment may include an electric motor operatively coupled to a mechanism to move fluid (e.g., a compressor, a pump, etc.).

As an example, one or more computer-readable media can include computer-executable instructions executable by a computer to instruct the computer to: receive simulation results for physical phenomena associated with a production system modeled by a network model; and analyze the simulation results.

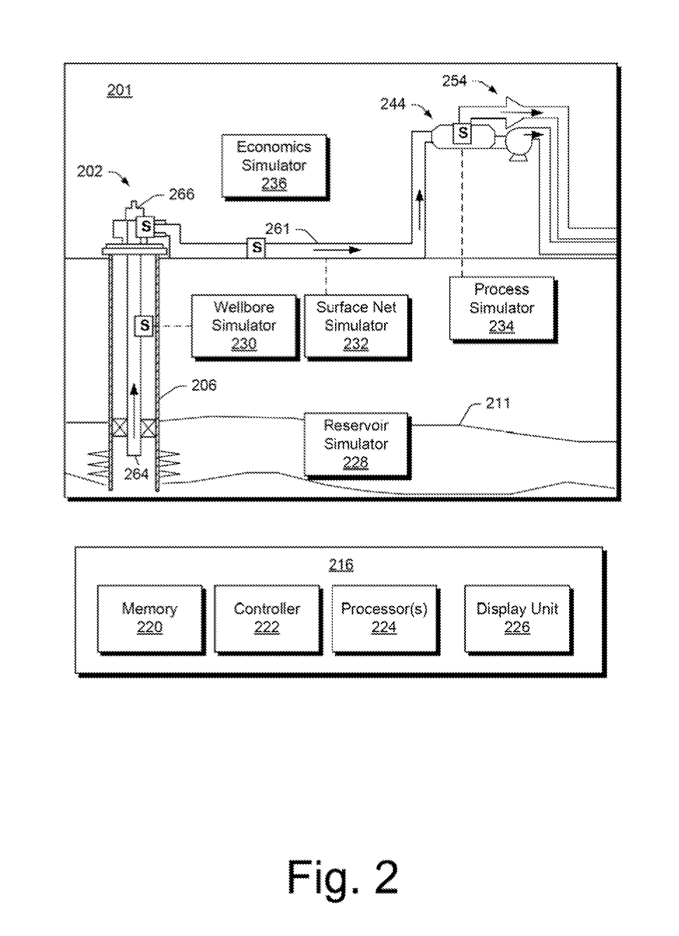

FIG. 2 shows an example of a schematic view of a portion of a geologic environment 201 that includes equipment. As shown in FIG. 2, the environment 201 includes a wellsite 202 and a network 244. The wellsite 202 includes a wellbore 206 extending into earth as completed and prepared for production of fluid from a reservoir 211.

In the example of FIG. 2, wellbore production equipment 264 extends from a wellhead 266 of the wellsite 202 and to the reservoir 211 to draw fluid to the surface. As shown, the wellsite 202 is operatively connected to the network 244 via a transport line 261. As indicated by various arrows, fluid can flow from the reservoir 211, through the wellbore 206 and onto the network 244. Fluid can then flow from the network 244, for example, to one or more fluid processing facilities.

In the example of FIG. 2, sensors (S) are located, for example, to monitor various parameters during operations. The sensors (S) may measure, for example, pressure, temperature, flowrate, composition, and other parameters of the reservoir, wellbore, gathering network, process facilities and/or other portions of an operation. As an example, the sensors (S) may be operatively connected to a surface unit 216 (e.g., to instruct the sensors to acquire data, to collect data from the sensors, etc.).

In the example of FIG. 2, the surface unit 216 can include computer facilities, such as a memory device 220, a controller 222, one or more processors 224, and display unit 226 (e.g., for managing data, visualizing results of an analysis, etc.). As an example, data may be collected in the memory device 220 and processed by the processor(s) 224 (e.g., for analysis, etc.). As an example, data may be collected from the sensors (S) and/or by one or more other sources. For example, data may be supplemented by historical data collected from other operations, user inputs, etc. As an example, analyzed data may be used to in a decision making process.

In the example of FIG. 2, a transceiver may be provided to allow communications between the surface unit 216 and one or more pieces of equipment in the environment 201. For example, the controller 222 may be used to actuate mechanisms in the environment 201 via the transceiver, optionally based on one or more decisions of a decision making process. In such a manner, equipment in the environment 201 may be selectively adjusted based at least in part on collected data. Such adjustments may be made, for example, automatically based on computer protocol, manually by an operator or both. As an example, one or more well plans may be adjusted (e.g., to select optimum operating conditions, to avoid problems, etc.).

To facilitate data analyses, one or more simulators may be implemented (e.g., optionally via the surface unit 216 or other unit, system, etc.). As an example, data fed into one or more simulators may be historical data, real time data or combinations thereof. As an example, simulation through one or more simulators may be repeated or adjusted based on the data received.

In the example of FIG. 2, simulators can include a reservoir simulator 228, a wellbore simulator 230, and a surface network simulator 232, a process simulator 234 and an economics simulator 236. As an example, the reservoir simulator 228 may be configured to solve for hydrocarbon flow rate through a reservoir and into one or more wellbores. As an example, the wellbore simulator 230 and surface network simulator 232 may be configured to solve for hydrocarbon flow rate through a wellbore and a surface gathering network of pipelines. As to the process simulator 234, it may be configured to model a processing plant where fluid containing hydrocarbons is separated into its constituent components (e.g., methane, ethane, propane, etc.), for example, and prepared for further distribution (e.g., transport via road, rail, pipe, etc.) and optionally sale. As an example, the economics simulator 236 may be configured to model costs associated with at least part of an operation.

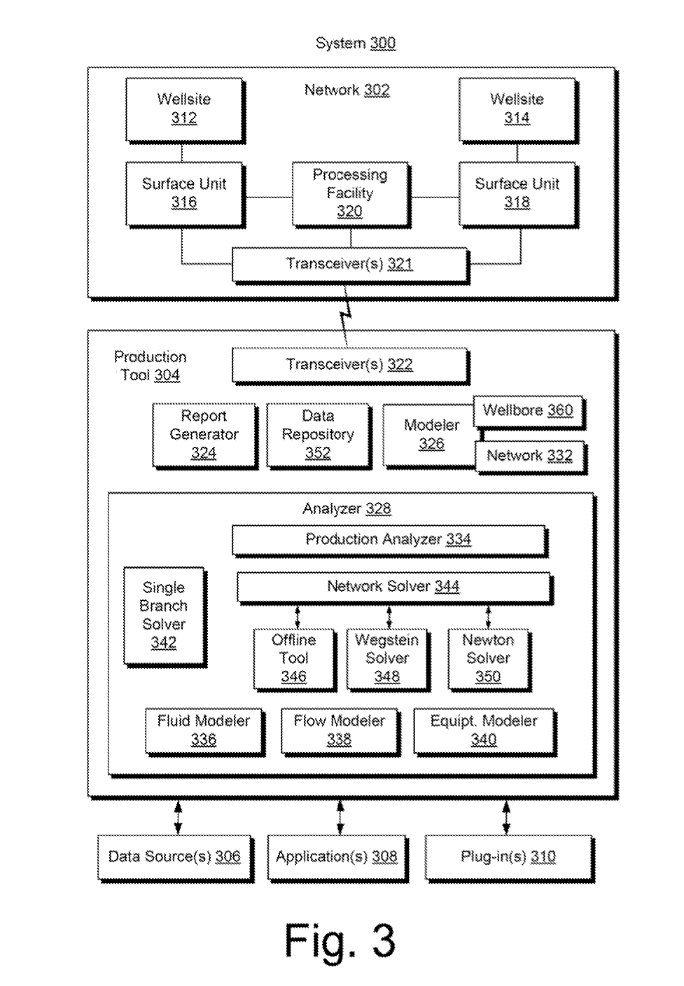

FIG. 3 shows an example of a schematic diagram of a production system 300 for performing oilfield production operations. As shown in the example of FIG. 3, the production system 300 can include an oilfield network 302, an oilfield production tool 304, one or more data sources 306, one or more oilfield application(s) 308, and one or more plug-in(s) 310. As an example, the oilfield network 302 can be an interconnection of pipes (e.g., conduits) that connects wellsites (e.g., a wellsite 1 312, a wellsite n 314, etc.) to a processing facility 320. A pipe in the oilfield network 302 may be connected to a processing facility (e.g., a processing facility 320), a wellsite (e.g., the wellsite 1 312, the wellsite n 314, etc.), and/or a junction in which pipes are connected. As an example, flow rate of fluid and/or gas into pipes may be adjustable; thus, certain pipes in the oilfield network 302 may be choked or closed so as to not allow fluid and/or gas through the pipe. A pipe may be considered open (e.g., optionally choked) when the pipe allows for flow of fluid and/or gas. As to a choke, choking may allow for adjusting one or more characteristics of a piece of flow equipment (e.g., a cross-sectional flow area, etc.), for example, for adjusting to fully open flow, for adjusting to choked flow and/or for adjusting to no flow (e.g., closed).

As an example, a choke may include an orifice that is used to control fluid flow rate or downstream system pressure. As an example, a choke may be provided in any of a variety of configurations (e.g., for fixed and/or adjustable modes of operation). As an example, an adjustable choke may enable fluid flow and pressure parameters to be changed to suit process or production requirements. As an example, a fixed choke may be configured for resistance to erosion under prolonged operation or production of abrasive fluids.

The oilfield network 302 may be a gathering network and/or an injection network. A gathering network may be an oilfield network used to obtain hydrocarbons from a wellsite (e.g., the wellsite 1 312, the wellsite n 314, etc.). In a gathering network, hydrocarbons may flow from the wellsites to the processing facility 320. An injection network may be an oilfield network used to inject the wellsites with injection substances, such as water, carbon dioxide, and other chemicals that may be injected into the wellsites. In an injection network, the flow of the injection substance may flow towards the wellsite (e.g., toward the wellsite 1 312, the wellsite n 314, etc.).

The oilfield network 302 may also include one or more surface units (e.g., a surface unit 1 316, a surface unit n 318, etc.), for example, a surface unit for each wellsite. Such surface units may include functionality to collect data from sensors (see, e.g., the surface unit 216 of FIG. 2). Such sensors may include sensors for measuring flow rate, water cut, gas lift rate, pressure, and/or other such variables related to measuring and monitoring hydrocarbon production. As shown, the oilfield network 302 can include one or more transceivers 321, for example, to receive information, to transmit information, to receive information and transmit information, etc. As an example, information may be received and/or transmitted via wire and/or wirelessly. As an example, information may be received and/or transmitted via a communications network such as, for example, the Internet, the Cloud, a cellular network, a satellite network, etc.

As an example, the oilfield production tool 304 may be connected to the oilfield network 302. The oilfield production tool 304 may be a simulator (e.g., a simulation framework) or a plug-in for a simulator (e.g., or other application(s)). The oilfield production tool 304 may include one or more transceivers 322, a report generator 324, an oilfield modeler 326, and an oilfield analyzer 328. As an example, the one or more transceivers 322 may be configured to receive information, to transmit information, to receive information and transmit information, etc. As an example, information may be received and/or transmitted via wire and/or wirelessly. As an example, information may be received and/or transmitted via a communications network such as, for example, the Internet, the Cloud, a cellular network, a satellite network, etc.

As an example, one or more of the one or more transceivers 322 may include functionality to collect oilfield data. The oilfield data may be data from sensors, historical data, or any other such data. One or more of the one or more transceivers 322 may also include functionality to interact with a user and display data such as a production result.

As an example, the report generator 324 can include functionality to produce graphical and textual reports. Such reports may show historical oilfield data, production models, production results, sensor data, aggregated oilfield data, or any other such type of data.

As an example, the data repository 352 may be a storage unit and/or device (e.g., a file system, database, collection of tables, or any other storage mechanism) for storing data, such as the production results, sensor data, aggregated oilfield data, or any other such type of data. As an example, the data repository 352 may include multiple different storage units and/or hardware devices. Such multiple different storage units and/or devices may or may not be of the same type or located at the same physical site. As an example, the data repository 352, or a portion thereof, may be secured via one or more security protocols, whether physical, algorithmic or a combination thereof (e.g., data encryption, secure device access, secure communication, etc.).

In the example of FIG. 3, the oilfield modeler 326 can include functionality to create a model of a wellbore and an oilfield network. As shown, the oilfield modeler 326 includes a wellbore modeler 330 and a network modeler 332. As an example, the wellbore modeler 330 can allow a user to create a graphical wellbore model or single branch model. As an example, a wellbore model can define operating parameters (e.g., actual, theoretical, etc.) of a wellbore (e.g., pressure, flow rate, etc). As an example, a single branch model may define operating parameters of a single branch in an oilfield network.

As to the network modeler 332, it may allow a user to create a graphical network model that combines wellbore models and/or single branch models. As an example, the network modeler 328 and/or wellbore modeler 330 may model pipes in the oilfield network 302 as branches of the oilfield network 302 (e.g., optionally as one or more segments, optionally with one or more nodes, etc.). In such an example, each branch may be connected to a wellsite or a junction. A junction may be defined as a group of two or more pipes that intersect at a particular location (e.g., a junction may be a node or a type of node).

As an example, a modeled oilfield network may be formed as a combination of sub-networks. In such an example, a sub-network may be defined as a portion of an oilfield network. For example, a sub-network may be connected to the oilfield network 302 using at least one branch. Sub-networks may be a group of connected wellsites, branches, and junctions. As an example, sub-networks may be disjoint (e.g., branches and wellsites in one sub-network may not exist in another sub-network).

As an example, the oilfield analyzer 328 can include functionality to analyze the oilfield network 302 and generate a production result for the oilfield network 302. As shown in the example of FIG. 3, the oilfield analyzer 328 may include one or more of the following: a production analyzer 334, a fluid modeler 336, a flow modeler 338, an equipment modeler 340, a single branch solver 342, a network solver 344, a Wegstein solver 346, a Newton solver 350, and an offline tool 346.

As an example, the production analyzer 334 can include functionality to receive a workflow request and interact with the single branch solver 342 and/or the network solver 344 based on particular aspects of the workflow. For example, the workflow may include a nodal analysis to analyze a wellsite or junction of branches, pressure and temperature profile, model calibration, gas lift design, gas lift optimization, network analysis, and other such workflows.

As an example, the fluid modeler 336 can include functionality to calculate fluid properties (e.g., phases present, densities, viscosities, etc.) using one or more compositional and/or black-oil fluid models. The fluid modeler 336 may include functionality to model oil, gas, water, hydrate, wax, and asphaltene phases. As an example, the flow modeler 338 can include functionality to calculate pressure drop in pipes (e.g., pipes, tubing, etc.) using industry standard multiphase flow correlations. As an example, the equipment modeler 340 can include functionality to calculate pressure changes in equipment pieces (e.g., chokes, pumps, compressors, etc.). As an example, one or more substances may be introduced via a network for purposes of managing asphaltenes, waxes, etc. As an example, a modeler may include functionality to model interaction between one or more substances and fluid (e.g., including material present in the fluid).

As an example, the single branch solver 342 may include functionality to calculate the flow and pressure drop in a wellbore or a single flowline branch given various inputs.

As an example, the network solver 344 can includes functionality calculate a flow rate and pressure drop throughout the oilfield network 302. The network solver 344 may be configured to connect to the offline tool 346, the Wegstein solver 348, and the Newton solver 350. As an example, alternatively or additionally, one or more other solvers may be provided, for example, consider a sequential linear programming solver (SLP), a sequential quadratic programming solver (SQP), etc. As an example, a solver may be part of the production tool 304, part of the analyzer 328 of the production tool 304, part of a system to which the production tool 304 may be operatively coupled, etc.

As an example, the offline tool 346 may include a wells offline tool and a branches offline tool. A wells offline tool may include functionality to generate a production model using the single branch solver 342 for a wellsite or branch. A branches offline tool may include functionality to generate a production model for a sub-network using the production model for a wellsite, a single branch, or a sub-network of the sub-network.

As an example, a production model may be capable of providing a description of a wellsite with respect to various operational conditions. A production model may include one or more production functions that may be combined, for example, where each production function may be a function of variables related to the production of hydrocarbons. For example, a production function may be a function of flow rate and/or pressure. Further, a production function may account for environmental conditions related to a sub-network of the oilfield network 302, such as changes in elevation (e.g., for gravity head, pressure, etc.), diameters of pipes, combination of pipes, and changes in pressure resulting from joining pipes. A production model may provide estimates of flow rate for a wellsite or sub-network of an oilfield network.

As an example, one or more separate production functions may exist that can account for changes in one or more values of an operational condition. An operational condition may identify a property of hydrocarbons or injection substance. For example, an operational condition may include a watercut (WC), reservoir pressure, gas lift rate, etc. Other operational conditions, variables, environmental conditions may be considered.

As to the network solver 344, in the example of FIG. 3, it is shown as being connected to the Wegstein solver 348 and/or the Newton solver 350. The Wegstein solver 348 and the Newton solver 350 include functionality to combine a production model for several sub-networks to create a production result that may be used to plan an oilfield network, optimize flow rates of wellsites in an oilfield network, and/or identify and address faulty components within an oilfield network. The Wegstein solver 348 can use an iterative method with Wegstein acceleration.

An oilfield network may be solved by identifying pressure drop (e.g., pressure differential), for example, through use of momentum equations. As an example, an equation for pressure differential may account for factors such as fluid potential energy (e.g., hydrostatic pressure), friction (e.g., shear stress between conduit wall and fluid), and acceleration (e.g., change in fluid velocity). As an example, an equation may be expressed in terms of static reservoir pressure, a flowing bottom hole pressure and flowrate. As an example, equations may account for vertical, horizontal or angled arrangements of equipment. Various examples of equations may be found in a multiphase flow simulator such as the simulator of the PIPESIM™ simulation framework (Schlumberger Limited, Houston, Tex.), which may be implemented for design and diagnostic analysis of oil and gas production systems. As an example, a simulation framework may provide for building a model; fluid and multiphase flow modeling; reservoir, well and completion modeling; field equipment modeling; and operations (e.g., artificial lift, gas lift, wax prediction, nodal analysis, network analysis, field planning, multi-well analysis, etc.).

As an example, an equation for pressure differential (e.g., AP) may be rearranged to solve for flow rate (e.g., Q), where the equation may include the Reynolds number (e.g., Re, a dimensionless ratio of inertial to viscous forces), one or more friction factors (e.g., which may depend on flow regime), etc.

Through use of equations for flow into and out of a branch and equating to zero, a linear matrix in unknown pressures may be obtained. As an example, fixed flow branches (i.e., branches in which the flow does not change) may be solved directly for the node pressures.

Thus, as an example, the Wegstein Solver 348 may perform a process as follows: (1) obtain initial estimates for the frictional and elevational resistances from the production models; (2) solve the linear system for the unknown node pressures; (3) calculate resulting flow rates; (4) calculate pressure residuals at each internal node; and (5) determine whether the maximum of the pressure residuals is lower than the tolerance. If the maximum pressure residual is not lower than the tolerance then the Wegstein solver may continue by rerun all the branches, with the pressure and flows calculated in items (2) and (3) above to re-estimate the branch resistances. Further, Wegstein acceleration may be applied to the resistances before returning to item (2).

The Newton solver 344 implements a Newton-Raphson technique for solving a system of non-linear equations. The Newton-Raphson technique can be applied iteratively for solving a system of non-linear equations defined by a vector of unknown variables and associated residual equations. Following an initial guess, iterations commence, for example, until one or more criteria are met (e.g., number of iterations, error, etc.). Updates for each iteration of the Newton-Raphson technique may be generated by solving a matrix equation that includes a Jacobian matrix formed by differentiating residual equations with respect to the variables. As an example, an adjustable factor may be used to adjust from a pure Newton-Raphson type of update to another type of update.

The Newton solver 344 includes functionality to solve the oitfield network 302 by implementing the Newton method (discussed above). Below is an example of how the Newton solver may be used to solve oilfield network 302.

For solving an oilfield network, a process may include: (1) defining variables and residual equations; (2) determine initial solution; (3) calculating residual and Jacobian matrix for each iteration; (4) solve Jacobian equation for the Newton update; (5) optionally determining adjustment factor; and (6) updating the solution.

With regards to item (1), defining variables and residual equations, branches in an oilfield network may include a number of equipment items. Each branch may be divided into sub-branches with each sub-branch containing a single equipment item. As an example, a new node may be used to join each pair of sub-branches. In this example, primary Newton-Raphson variables can include a flow (Qib) in each sub-branch in the network and a pressure Pᵢₙ at each node in the network. In this example, temperature (or enthalpy) and composition may be treated as secondary variables.

As an example, residual equations may include a branch residual, an internal node residual, and a boundary condition. In such an example, a branch residual for a sub-branch relates the branch flow to the pressure at the branch inlet node and the pressure at the outlet node. As an example, internal node residuals can define where total flow into a node is equal to total flow out of the node.

As an example, determining an initial solution may be performed using a production model where for each subsequent iteration, a Jacobian matrix is calculated. The values of the Jacobian matrix may be used to solve a Jacobian equation for the Newton-Raphson update. To solve the Jacobian equation, one or more types of matrix solvers may be used.

In the example of FIG. 3, the one or more data sources 306 include one or more types of repositories for data. For example, the one or more data sources 306 may be Internet sources, sources from a company having ties to the oilfield network 302, or any other location in which data may be obtained. The data may include historical data, data collected from other oilfield networks, data collected from the oilfield network being modeled, data describing environmental or operational conditions.

In the example of FIG. 3, the one or more oilfield applications 308 may be applications related to the production of hydrocarbons. The one or more oilfield applications 308 may include functionality to evaluate a formation, manage drilling operations, evaluate seismic data, evaluate workflows in the oilfield, perform simulations, or perform any other oilfield related function. In the example of FIG. 3, the one or more plug-ins 310 may allow integration with packages such as, for example, a TUFPP model, an OLGA™ model, an Infochem Multiflash model (Infochem Computer Services Ltd., London, UK), an equipment model, etc.

While the example of FIG. 3 shows the oilfield production tool 304 as a separate component from the oilfield network 302, the oilfield production tool 304 may alternatively be part of the oilfield network 302. For example, the oilfield production tool 304 may be located at one of the wellsites (e.g., the wellsite 1 312, the wellsite n 314, etc.), at the processing facility 320, or any other location in the oilfield network 302. As another example, the oilfield production tool 304 may exist separate from the oilfield network 302, such as when the oilfield production tool 304 is used to plan the oilfield network.

Various types of numerical solution schemes may be characterized as being explicit or implicit. For example, when a direct computation of dependent variables can be made in terms of known quantities, a scheme may be characterized as explicit. Whereas, when dependent variables are defined by coupled sets of equations, and either a matrix or iterative technique is implemented to obtain a solution, a scheme may be characterized as implicit.

As an example, a scheme may be characterized as adaptive implicit (“AIM”). An AIM scheme may adapt, for example, based on one or more gradients as to one or more variables, properties, etc. of a model. For example, where a model of a subterranean environment includes a region where porosity varies rapidly with respect to one or more physical dimensions (e.g., x, y, or z), a solution for one or more variables in that region may be modeled using an implicit scheme while an overall solution for the model also includes an explicit scheme (e.g., for one or more other regions for the same one or more variables).

As an example of an AIM scheme, consider an AIM scheme available as part of the ECLIPSE™ 300 reservoir simulator marketed by Schlumberger Ltd. (Houston, Tex.). The ECLIPSE™ 300 reservoir simulator may implement a fully implicit scheme or an implicit-explicit scheme that is implicit in pressure and explicit in saturation, known as IMPES. In the fully implicit scheme, values for both pressure and saturation are provided at the end of each simulation time-step; whereas, the IMPES scheme uses saturation values from the beginning of the time-step to solve for pressure values at the end of the time-step. In such examples, a reservoir simulator iterates until pressures values in grid blocks of a model of the reservoir being simulated have reached some internally consistent solution. However, a solution may be difficult to find if saturation (which the IMPES scheme assumes is constant within a time-step) changes rapidly during that time-step (e.g., a large percentage change in grid block values for saturation). The IMPES scheme may be able to cope with such an issue by decreasing “length” (e.g., duration) of the time-step but at the cost of more time-steps (e.g., in an effort to achieve a more stable solution).

The aforementioned fully implicit scheme may be a more stable option with saturation and pressure being obtained simultaneously so as any difference between their values for one time-step and a next time-step does not disturb a solution process as much as when compared to the IMPES scheme. Thus, in a fully implicit scheme, the “length” (e.g., duration) of a time-step may be larger but it also means that the fully implicit scheme may take additional processing time to achieve solutions (e.g., in comparison with an IMPES scheme). However, in a reservoir where properties change rapidly, a fully implicit scheme may provide a solution in less computational time than an IMPES scheme, even though an iteration of the fully implicit scheme may take longer to complete when compared to an iteration of the IMPES scheme.

The aforementioned ECLIPSE™ 300 reservoir simulator may also implement one or more modules such as a black-oil simulator module, a compositional simulator module, or a thermal simulator module. As an example, a black-oil simulator module may include equations to model three fluid phases (e.g., oil, water, and gas, with gas dissolving in oil and oil vaporizing in gas); as an example, a compositional simulator module may include equations to model phase behavior and compositional changes; and, as an example, a thermal simulator module may include equations to model a thermal recovery processes such as steam-assisted gravity drainage (SAGD), cyclic stream operations, in situ combustion, heater, and cold heavy oil production with sand.

As to network models, as an example, a method can include simulation of steady state operation of an oil and gas production system over various ranges of operating conditions and configurations. In such an example, the method may include an implicit evaluation of conservation of energy equations in addition to mass and momentum as an effective technique for efficiently and robustly simulating the production system where, for example, the production system includes fluid such as heavy oil, steam or other fluids at or near critical pressures or temperatures. The term “critical point” is sometimes used herein to specifically denote a vapor-liquid critical point of a material, above which distinct liquid and gas phases do not exist.

As mentioned, a production system can provide for transportation of oil and gas fluids from well locations along flowlines which are interconnected at junctions to combine fluids from many wells for delivery to a processing facility. Along these flowlines (including at one or more ends of a flowline), production equipment may be inserted to modify the flowing characteristics like flow rate, pressure, composition and temperature. As an example, a boundary condition may depend on a type of equipment, operation of a piece of equipment, etc.

As an example, a simulation may be performed using one type of equipment along a flowline and another simulation may be performed using another type of equipment along the same flowline, for example, to determine which type of equipment may be selected for installation in a production system.

As an example, a simulation may be performed using one type of equipment at a position (e.g., with respect to a flowline) and another simulation may be performed using another type of equipment at a different position (e.g., with respect to the same flowline or a different flowline), for example, to determine which type of equipment may be selected for installation in a production system as well as to determine where a type of equipment may be installed. As an example, a simulation may be performed using one type of equipment at a position (e.g., with respect to a flowline) and another simulation may be performed using that type of equipment at a different position (e.g., with respect to the same flowline or a different flowline), for example, to determine where that type of equipment may be installed.

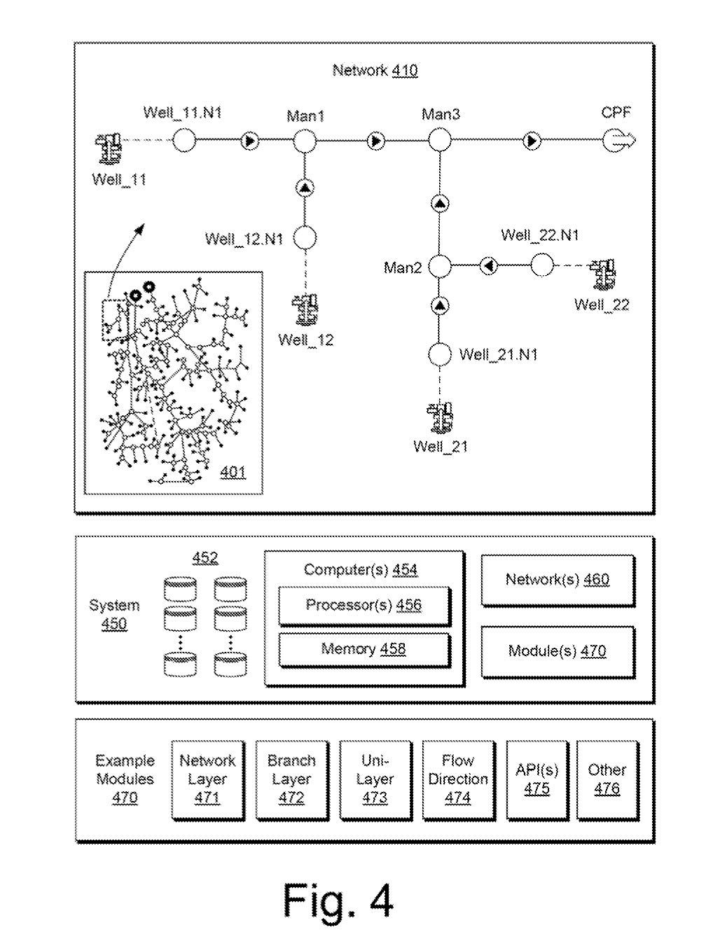

FIG. 4 shows an example of a relatively small production system network 410 (e.g., optionally a portion of a larger network 401), an example of a system 450 and examples of modules 470. As shown, the network 410 forms somewhat of a tree like structure where flowlines represent branches (e.g., segments) and junctions represent nodes. As shown in FIG. 4, the network 410 provides for transportation of oil and gas fluids from well locations along flowlines interconnected at junctions with final delivery at a central processing facility.

Given information of operating condition(s) at boundary nodes (e.g., where fluid enters and exists the system) and the physical environment between them (e.g., geographical location, elevation and ambient temperature), a production engineer may aim to design a production system that meets business and regulatory requirements constrained to operating limits of available equipment.

As an example, a method can include implementing one or more modules to simulate steady state operation of a production system, for example, as including a network (e.g., as a sub-network, etc.) as in the example of FIG. 4 (also see, e.g., FIG. 1). Such a method may include simulating the steady state operation over a selected range of operating conditions and configurations (e.g., optionally a broadest reasonable range).

An example is provided below as to equations that may be formulated to model a network and to simulate operation of a production system represented by the network.

Consider a network with n_{N} nodes and n_{B} branches as depicted in FIG. 4. Among the n_{N} nodes, there are n_{IN} internal nodes and n_{BN} boundary nodes. A method can include indexing internal nodes with indices i, i=1, . . . , n_{IN}, branches with j, j=1, . . . , n_{B}, and boundary node with k, k=n_{IN}+1, . . . , n_{N}. Such a method can include letting V_{I} denote the set of internal nodes, and V_{B} denote the set of boundary nodes. For example, a method can include letting V=V_{I} ∪V_{B} to denote a set of nodes. Further, such a method can include letting A denote the set of branches. By topology of the network 410, it is also possible to define a set of maps that relate the branches to the nodes. For example, let φ_{I} denote the map from the branch index j to its inlet node index a; let φ_{O} denote the map from the branch index j to its outlet node index b; let φ_{S} denote the map from the branch index j to its geometric start node index s; let φ_{E} denote the map from the branch index j to its geometric end node index e; and let φ_{J} denote the map from a node index b to the set of its connected branches. i.e., φ_{J}(b)={j: φ_{I}(j)=b or φ_{O}(j)=b}. Note, as an example, geometric start and end nodes may not necessarily correspond to the inlet and outlet nodes. For example, in a case where they flip, the flow rate Qⱼ in that branch can be negative.

To model the network 410, a set of equations can include terms for conservation of momentum, conservation of mass and conservation of energy. A set of implicit variables may be formulated, for example, where the following are implicit: pressure P at each node, flow rate Q in each branch and temperature T at each node. In such an example, two intermediate variables may be defined as follows: composition C as a function of Q and enthalpy H as a function of P and T.

As an example, an approach that provides flexibility as to treatment of enthalpy/temperature as implicit variables may optionally be applied in situations where, for example, one or more fluids such as heavy oil, water, steam, etc. are present and, for example, where pressure/temperature for one or more fluids are near a critical point (e.g., a vapor-liquid critical point of fluid, above which distinct liquid and gas phases do not exist). To provide enthalpy/temperature flexibility, conservation equations may be defined (e.g., for a Jacobian matrix).

As an example, equipment may be modeled as being adiabatic (e.g., adiabatic devices), for example, on the basis that equipment lengths are substantially smaller than pipe lengths and that heat loss over such equipment can be suitably considered as being negligible. However, for compressors and pumps, a formulation can optionally consider heat gain as a result of loss of total efficiency (e.g., based on manufacturer specifications for efficiency with respect to operational conditions, etc.).

As an example, for instances without an explicit formula for change of enthalpy with respect for pressure and temperature, it is possible to implement one or more flash algorithms provided as a package or packages, for example, to calculate numerical derivatives. As an example, a formulation and solution process may include implementing one or more flash packages that include features to calculate one or more analytical derivatives.

As an example, a network simulator may take an all-or-nothing approach where each piece of equipment is either considered as being alone in a branch or the user specifies the boundary of the branch. In the first case, the branch extent may be reconstructed a posteriori. The second case of the branch approach may provide a user with a view of aggregated data over a portion of the network easily like the max flow in a branch or the profile of a branch. However such an approach may rely on some input from the user to set the branch boundary and, even if this can be straightforward in a simple network, if may become more difficult and cumbersome in more complex cases due to unidirectional equipment, non-existing material point to break the branch, etc. As an example, by implementing to a single layer editor, which may flatten a network hierarchy, usability may be enhanced for one or more tasks.

As an example, a simulation tool such as, for example, the PIPESIM® framework, may be implemented to understand better various aspects of a network (e.g., to predict behavior during design, etc.). In operation, conditions may change in a network that can cause transient effects beyond a normal steady operating limit of associated infrastructure. For example, deposition of solids can stop flow and result in increased cost. Monitoring a network can help to identify risk, possibly before occurrence of stoppage, slowdown, or other types of issues. As an example, a directionality process may aid in determinations as to direction of flow and, for example, “continuity” of flow in a given branch.

As an example, a method may provide a way to split a network into a minimum number of branches a priori while aiming to guarantee unidirectional flow in a branch and, for example, allowing for monitoring to prevent unwanted branch shutdown. Such a method may enable external driving of a framework by optimizers, for example, issuing commands on a given branch.

As shown in FIG. 4, the system 450 includes one or more information storage devices 452, one or more computers 454, one or more networks 460 and one or more modules 470. As to the one or more computers 454, each computer may include one or more processors (e.g., or processing cores) 456 and memory 458 for storing instructions (e.g., modules), for example, executable by at least one of the one or more processors. As an example, a computer may include one or more network interfaces (e.g., wired or wireless), one or more graphics cards, a display interface (e.g., wired or wireless), etc. As an example, imagery such as surface imagery (e.g., satellite, geological, geophysical, etc.) may be stored, processed, communicated, etc. As an example, data may include SAR data, GPS data, etc. and may be stored, for example, in one or more of the storage devices 452.

As an example, the one or more modules 470 may include instructions (e.g., stored in memory) executable by one or more processors to instruct the system 450 to perform various actions. As an example, the system 450 may be configured such that the one or more modules 470 provide for establishing a framework, for example, that can perform network modeling. As an example, one or more methods, techniques, etc. may be performed using one or more modules, which may be, for example, one or more of the one or more modules 470 of FIG. 4.

As an example, a system may include modules for rendering one or more graphical user interfaces (GUIs) to a display, a screen, etc. (e.g., whether local, remote, local and remote, touch, etc.). As an example, rendering may occur via one or more processors (e.g., optionally one or more GPUs, etc.) where information may be transmitted to a display, a projector, a network, a printer, etc. In such an example, at least a portion of the information may be for creating a visual (e.g., on a display, on a screen, via a printer, etc.). As an example, a method may include rendering information where such rendering may occur at least in part via execution of one or more modules such as, for example, one or more graphics modules (e.g., consider OpenGL, Direct3D, etc.). As an example, a method that includes rendering may include rendering information such as image (e.g., picture, etc.) information, vector information, text information, etc.

FIG. 4 shows example modules 470 as including a network layer module 471, a branch layer module 472, a “uni-layer” module 473, a flow assessment module 474, one or more application programming interface (API) modules 475 and one or more other modules 476.

As an example, a framework may implement an approach that includes a network layer and a branch layer. As an example, a framework may implement another approach, which may be referred to as a “uni-layer” approach. For example, given a flow network to solve, a framework may receive input that models the flow network for assessment using a network simulator. In such an example, the network simulator may include a layer, for example, defined without specifying a network layer and a branch layer (e.g., without a branch concept and where equipment may be directly exposed). In such an example, a model of a network may include constructs for equipment such as, for example, compressors, sources, sinks, connected flowlines, junctions, etc. where such constructs may represent physical and/or virtual junction points. Such a model may account for equipment that may be unidirection, bidirectional, directionless and/or having an explicit branch boundary (e.g., consider a well).

As an example, a bidirectional piece of equipment can be specified to include a first selectable direction and a second selectable direction (e.g., in terms of a hierarchy). In such an example, when flowing in the first selectable direction, the piece of equipment may have a given behavior that may differ from a given behavior in the second selectable direction (e.g., opposite or reverse to the first selectable direction). As an example, a manifold may provide for splitting its input into a plurality of branches. In such an example, there is a direction (e.g., input to outputs) that causes flow in a forward direction to be divided into the plurality of branches. However, when flow is in an opposite (e.g., reverse) direction, the plurality of branches may serve as inputs and the manifold may aggregate the individual flows of the plurality of branches to an output. As an example, an unidirectional piece of equipment is a piece of equipment that is specified to flow in a particular direction (e.g., a forward direction where flow in a reverse direction is prohibited). As an example, a directionless piece of equipment may be specified to allow for flow in multiple directions, for example, without alteration of behavior.

As an example, a framework may be implemented using various features of a system such as, for example, the system 450 of FIG. 4. As an example, one or more modules may be provided that include instructions that may be executed by a processor or processors. As an example, instructions may be provided for execution of instructions in parallel, for example, to consider multiple features of a network or networks that may be associated with a geologic environment such as the geologic environment 110 of FIG. 1.

As an example, a method may include concurrently processing information for at least a portion of a model of a network of a production system, for example, where the information may specify information as to branches and pieces of equipment. In such an example, concurrent processing may process information for multiple branches where, for example, information as to one or more pieces of equipment may be taken into account.

As an example, a system may include multiple processing elements that may be configured to execute concurrent tasks execute in parallel. In such an example, elements may be real, physical elements and/or virtual elements (e.g., consider virtualization of one or more processors, cores, etc.). As an example, a virtual machine or virtual machines may be instantiated on a system or systems, which may provide operating system environments that can execute an application or applications.

As an example, a system may include one or more modules for executing a hypervisor or hypervisors. In such an example, a hypervisor may perform actions, for example, to manage one or more virtual machines (e.g., one or more guest machines, etc.).

As an example, a system may include modules that provide for parallel networking of computers. In such an example, the computers may be leveraged for use as a distributed parallel processing system.

As an example, a system may include one or more modules for partitioning a model of a network of a production system into portions. In such an example, each of the portions may include one or more branches and/or one or more pieces of equipment. As an example, individual portions may be assigned to processing resources. For example, a processor core may be a processing resource that includes accessible memory, which may also be considered a processing resource. In such an example, processing may occur concurrently for multiple individual portions of the model of the network of the production system.

As an example, a system may include a master application that can partition tasks for execution via slave applications. In such an example, the slave applications may execute in operating system environments that may be established using cores, for example, where individual cores provide for individual operating system environments. As an example, a system may include one or more multicore processors. In such an example, a master application may execute in an operating system environment that can leverage multiple cores for execution of slave applications. As an example, a master application may be configured to perform tasks associated with a model of a network of a production system and the slave applications may be configured to perform tasks associated with individual portions of the model of the network of the production system, which may be portions optionally specified to a branch level (e.g., where the model of the network includes multiple branches that represent real and/or hypothetical physical branches of a production system). As an example, results from slave applications may be consolidate by a master application, which may be optionally configured to call for rendering information (e.g., via one or more GUIs, etc.). As an example, a framework may include a parallel solver, for example, to solve equations associated with a model of a network of a production system using resources configured for concurrent processing. As an example, a parallel solver may provide for distributed processing using resources with a system or disparate systems (e.g., network connected systems, etc.).

As an example, a framework may include one or more APIs. For example, a framework may include an interface for receipt of one or more calls where a call may include one or more parameters (e.g., a method name, data, value, etc.). As an example, a GUI may be implemented that allows a user to build, modify, edit, etc. a network. In such an example, graphic controls associated with the GUI may cause issuance of one or more API calls. For example, consider a GUI that includes a menu that lists types of equipment and a panel that displays a network. In such an example, upon dragging and dropping a type of equipment to a position with respect to the network, an API call may be transmitted to an interface of the framework. In such an example, the framework may parse the API call for information and, based at least in part on the information, edit a model of the network. As an example the GUI may be part of the framework and the API may be an internal API of the framework. As an example, a framework may include one or more internal APIs and/or one or more external APIs.

As an example, a framework may be instructed to determine the extent of one or more branches in a network, optionally automatically. In such an example, the framework may implement rules. For example, a rule may specify that separators and junctions with more than two connections are to be treated as an end of a branch. Such an approach may optionally consider state information as to, for example, connection states. As an example, an approach may be stateless with respect to connection states. As an example, a rule may specify that a branch is assigned a random direction and is started from terminal equipment or an internal node with a lowest numeric node identifier (e.g., node ID). In such an example, the internal node may be a node that has not been visited (e.g., assessed), for example, as part of an assessment as to flow.

As an example, a framework may implement a rule that instructions it to assess a branch until it reaches an end branch item or until a directional piece of equipment is encountered. In such an example, the framework may then set the direction of the branch, for example, from a randomly, or otherwise assigned, direction to a definite direction per an assessment of the branch. In such an example, other directional equipment that is not in the branch direction may be considered as a stop point for the branch. As an example, if a branch includes no directional equipment, a framework may implement a rule that sets the direction of that branch based on a direction of a profile direction of a first flowline encountered. In such an example, if there is no flowline, the branch direction may be assessed to be from a piece of terminal equipment or, for example, from internal node (e.g., with the lowest node identifier, etc.).

As an example, a framework may include instructions for changing a production well to an injection well, for example, based at least in part on received input (e.g., via a file, a GUI control, an input device, etc.).

As an example, an application programming interface (API) associated with a framework may be specified to account for one or more external branches, for example, as determined by a network topology and, for example, one or more internal branches as determined by a flowpath direction. For example, a call may be made via an API to a framework where the framework may implement logic, algorithms, rules, etc. that can decide or determine whether a branch is an external branch or whether a branch is an internal branch. In such an example, a user may interact with a network model via a GUI where interactions may make API calls and where information may be returned in response thereto and where such information may be consumed by rendering circuitry to update the GUI. For example, upon making a change, adding a piece of equipment, etc., an API call may be made and processed where, in response, information may be provided as to a flow direction, a flow restriction, a flow condition, etc. associated with the change, the addition of the piece of equipment, etc. In such a manner, a user may receive feedback during building, editing, or otherwise interacting with a network model via a GUI.

As an example, structure may be aggregated by a framework engine, for example, based on branches that may be recorded in memory (e.g., consider a simulation engine file, etc.). For example, a result may include an information field in a header that may specify a start node, an end node and a direction. In such an example, consider the following: 2774; 2779; 1 (e.g., where semi-colons are used to separate information). In such an example, 2774 may be a node ID for a start node, 2779 may be a node ID for an end node and 1 may be an indicator for a direction (e.g., as specified, assigned, etc.).

As an example, a branch may be defined to include a set of individual pieces of equipment that may be connected by a path. In such an example, a framework may implement an assumption (e.g., a rule, etc.) that such a branch has a single flow direction as part of an analysis to determine the flow direction of the branch.

As to a set of individual pieces of equipment, a framework may implement one or more assumptions as to connection and orientation, for example, as may be specified by a list. As an example, a graphical user interface (GUI) may include graphic controls that can specify branch containers for so-called normal branches and for wells. As an example, an outer branch (e.g., or physical branch) may be a branch that is analogous to a topological non-directional branch. As an example, an inner branch or inner branches may be derived at least in part from an outer branch, for example, via assurance of a specific connectivity direction.

As an example, a GUI associated with a framework may allow for input via one or more graphic controls that can deactivate a branch. For example, a deactivated branch may be considered to be blocked and, for example, one or more pieces of equipment that are deactivated within a branch may be considered to be a junction or junctions. As an example, a GUI may generate one or more API calls in response to user input (e.g., pointing, dragging/dropping, selection of a menu item, etc.). In such an example, a framework may process the one or more API calls for purposes of specifying one or more features of a model of a network (e.g., whether a branch is active, not active, etc.). As an example, where a rule exists that may prohibit activation and/or deactivation, a transmitted API call as processed by a framework may result in the framework issuing a notification, optionally for display via a GUI (e.g., visually) or other notification mechanism (e.g., speaker, etc.).

As an example, a framework may implement a model that may be specified using a level where, for example, an inactive piece of equipment may be considered to be a junction or a connector. As an example, such a specification may be applied to one or more of sources, sinks, and/or wells. As an example, a GUI may display a network or a portion thereof where a branch with inactive equipment (e.g., and no active equipment) is not topologically ignored. In such an example, a branch with inactive equipment may be listed as an empty branch.

As an example, a framework may define connections points as junctions. For example, a junction with two connections may be an “artificial” junction and may be embedded in a branch (e.g., and not reported as a node). As an example, a non-artificial junction (e.g., a “true junction”) may be a point that may be at a compulsory branch split, for example, at least in part because it has three or more connections. As an example, one or more junctions may be treated as sources. For example, a junction as a source may be used as a starting point for a single branch operation. As an example, such a specification or attribute may be ignored in a network representation or, for example, if the junction is not a starting point of a single branch operation. As an example, a framework may implement a rule whereby a junction that is specified to be a source cannot be deactivated (e.g., if point x is a junction and a source, set to active or prohibit deactivation).

As an example, where pieces of equipment include one or more phase separators, a rule may apply to two phase separators as being single branch separators (e.g., two connections) or network separators (e.g., three connections). As an example, where three phase separators exist, these may be considered to be true junction points. As an example, an option may exist for implementation of one or more rules by a framework in response to receipt of an API call and an option may exist for implementation of one or more rules via selection of one or more rule specific menu items of a GUI. For example, a rule may be implemented using logic in response to processing of an API call (e.g., indirectly) or a rule may be implemented in response to processing of an API call that specifically calls for implementation of the rule (e.g., directly).

As an example, a framework may include instructions for rendering a GUI to a display where the GUI includes logic as to the concept of an inlet port and an outlet port, for example, to aid in determination of an overall direction of a branch. In such an example, rules may be implemented that can allow a user to know if a connection is being made on the inlet port or the outlet port may include: if there is a horizontal yellow arrow on the piece of equipment, the direction of the arrow is from inlet to outlet. In such an example, when fully disconnected, equipment may flow from left to right (e.g., inlet on the left side). In such an example, pieces of equipment with yellow horizontal arrows may be directional equipment. As an example, directional equipment may be split further into two sets (e.g., consider equipment that can flow in reverse where data may be inverted such that a multiplier becomes a divider). In such an example, consider equipment that may be generic equipment and/or multiplier/adder equipment. As an example, other directional equipment may be specified to be strictly directional and prohibited from flowing in a reverse direction. For example, consider equipment such as separators, compressors, expanders, pumps, etc.

As an example, a framework may include inlet and outlet specifications for equipment but not for flowlines or junctions. As an example, a junction may include a plurality of connections; whereas, a separator may include one inlet and, for example, a plurality of outlets (e.g., consider up to three outlets or more depending on the type of separator, type of separation, type of input, etc.). As an example, a framework may include rules associated with production wells (e.g., production wellheads) and sources such that one outlet is specified and may include rules associated with injection wells (e.g., production wellheads) and sinks such that one inlet is specified. As an example, a rule may be included that operates as a network license, for example, for purposes of establishing more than two connections at a point where more than two connections may be allowed.

As an example, a framework may include instructions for rendering one or more GUIs where one or more colors may be used as indicators. For example, a first color may represent branch direction and a second color may indicate profile direction. As an example, arrows may be rendered using one or more colors, for example, where arrowheads indicate direction of flow.

As an example, a workflow may include various actions. As an example, a workflow may be implemented using instructions in one or more modules. As an example, a workflow may be performed to create a network, to edit a network, etc.

As an example, a user may select pieces of equipment from a menu (e.g., a ribbon, etc.) of a GUI and drop in a panel (e.g., a canvas) of a GUI. In such an example, one or more pieces of the equipment may be directional or not, for example, as indicated graphically by an arrow associated with respective pieces of equipment. As an example, a user may connect equipment from an outlet of one piece of equipment to inlet of another piece of equipment. For non-directional equipment, one or more equipment ports may be specified to be an outlet or an inlet. As an example, for directional equipment, an inlet and an outlet may be aligned with a graphical arrow.

As an example, a framework may include instructions that implement rules, for example, consider a rule that allows a user to interconnect pieces of equipment as long as such interconnections do not directly connect two directional pieces of equipment in opposite direction. For example, upon an attempt to do so, a GUI may transmit an API call where a framework may process the API call and upon processing information therein with respect to such a rule, the framework may issue a response that such an action (e.g., interconnection) is prohibited (e.g., by rendering a notification to the GUI, etc.).

As an example, a user may instruct a framework (e.g., via GUI interaction, batch file or other instruction, etc.) to perform a simulation. In such an example, a simulation may break a network into branches and assess the branches in a manner that can guarantee a single flow direction per branch. In such an example, upon completion of the assessment (e.g., completion of the simulation), instructions may be used to render information graphically (e.g., as a GUI, etc.) where such rendered information may specify directions of flow in one or more branched of the network.

As an example, a framework may provide for “direction” reassurance in that a user may be able to place equipment without considering implications of direction, etc. a priori. In other words, such considerations may be handled by the framework where the framework may provide feedback as to violations of one or more rules, as to directions of equipment, etc. Such a framework may provide such feedback during a building stage, an editing stage, etc. of a network. As an example, simulation (e.g., assessment of a network) may occur “on the fly” or responsive to receipt of a request to perform a simulation. In response, a framework may cause, directly or indirectly, rendering of a GUI to a display, for example, where input may allow for interaction with the GUI to visualize flow in at least a portion of a network.

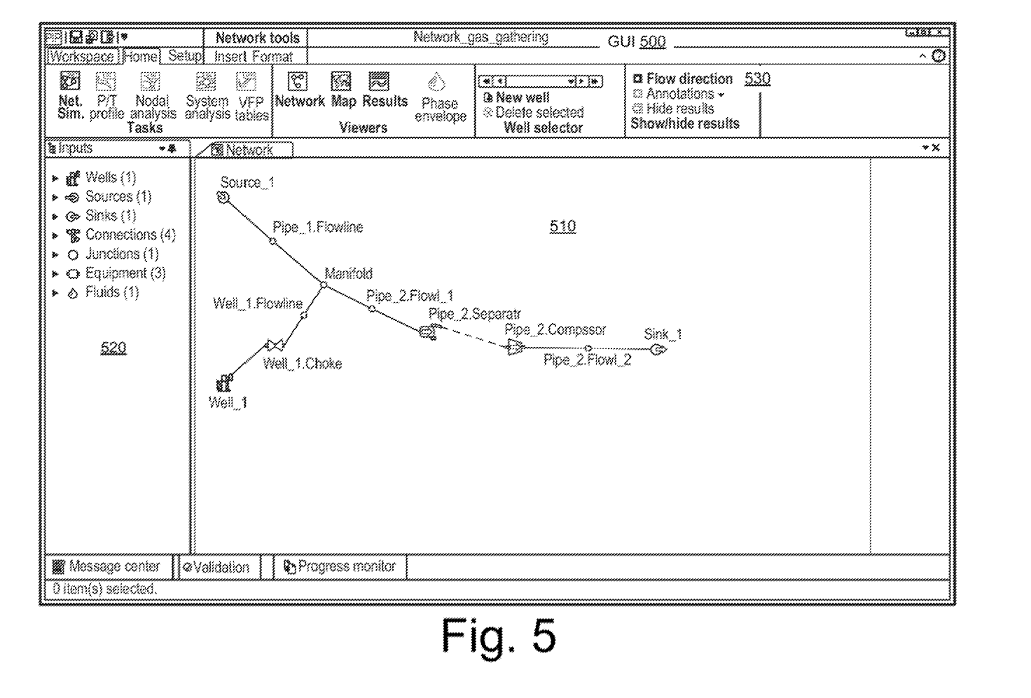

FIG. 5 shows an example of a graphical user interface (GUI) 500 that includes various controls and display regions for display of information, options, etc. As shown in the example of FIG. 5, the GUI 500 includes a region 510 for display of a network (e.g., Network X1), a region 520 for display of inputs (e.g., wells, sources, sinks, connections, junctions, equipment, fluids, etc.), and a region 530 for various options including a flow direction option.

As an example, given a flow network to solve, a user may model the network using a network simulator. In such an example, the network simulator may include a single layer (e.g., a uni-layer), for example, where there is no “branch concept” and pieces of equipment are directly exposed (e.g., via flattening). As an example, a network may include such equipment (e.g., compressor, source, sinks, flowlines connected, junctions, etc.) to mimic physical or virtual junction points. As an example, one or more pieces of equipment may be unidirectional, bidirectional (e.g., or directionless) or have an explicit branch boundary (consider, e.g., a well); noting that many types of pieces of equipment do not.

Referring to the network displayed in the region 510 of the GUI 500, as an example, a method may commence from one or more physical branches (e.g., materialized by a physical junction point or equipment) such as “Source_{—}1” to “Manifold”, “Manifold” to “Sink_{—}1” and then compute flow branches based on one or more equipment characteristics (consider, e.g., characteristics such as unidirectional and directionless), heuristics and/or rules.

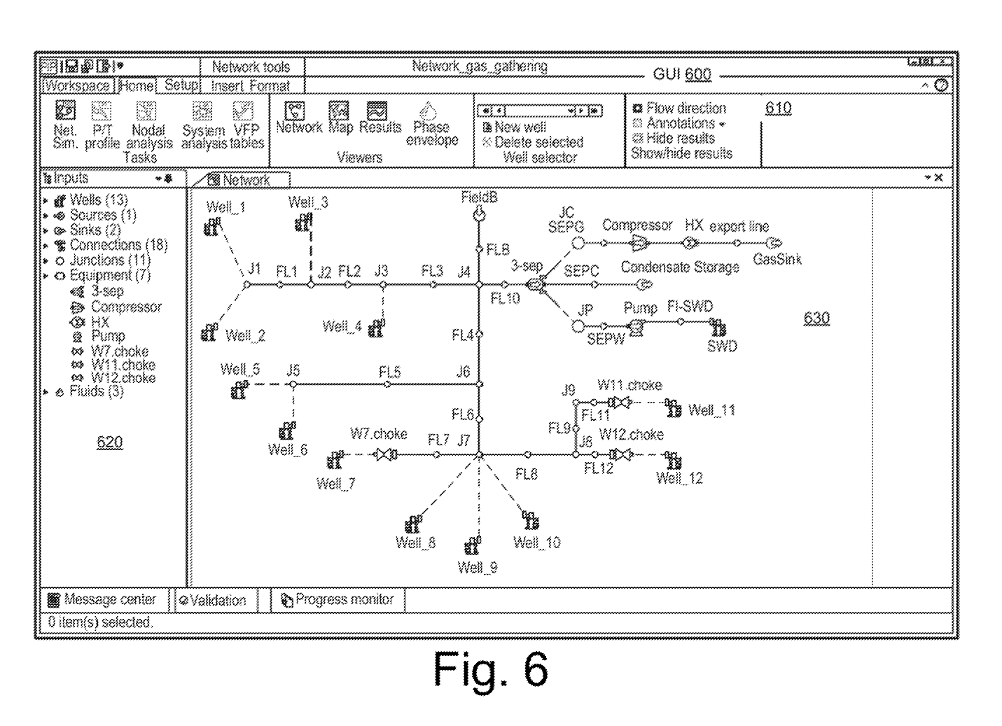

FIG. 6 shows an example of a graphical user interface (GUI) 600 that includes various controls and display regions for display of information, options, etc. As shown in the example of FIG. 6, the GUI 600 includes a region 610 for display of a network (e.g., Network X2), a region 620 for display of inputs (e.g., wells, sources, sinks, connections, junctions, equipment, fluids, etc.), and a region 630 for various options including a flow direction option.

As an example, the network displayed in the region 610 may be operatively coupled to the network displayed in the region 510 of the GUI 500 of FIG. 5. For example, Well_{—}1 in FIG. 6 may correspond to Well_{—}1 in FIG. 5.

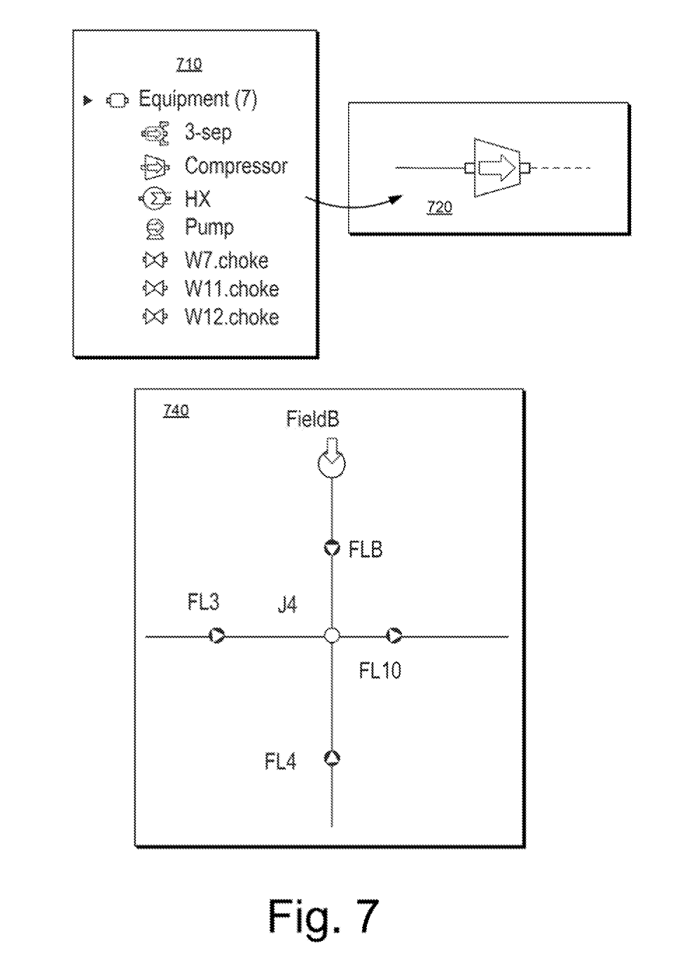

FIG. 7 shows an example of various types of equipment 710 such as a three-phase separator, a compressor, a heat exchanger, a pump, and chokes. As indicated, the compressor 720 operates with respect to an indicated direction (e.g., a characteristic of a compressor).

As an example, a method may commence by defining a set of characteristics for different types of equipment, for example, characterized as having strict direction, profile direction or no direction. In such an example, equipment with strict direction may be defined as not allowing for flow in a direction opposite the strict direction (e.g., or have a strict inlet and outlet). Graphically, a direction may be displayed as indicated for the compressor 720 as a particular type of arrow (e.g., a unidirectional arrow, a strict direction arrow, etc.). Examples of equipment that may be labeled with an arrow or arrows can include wells (e.g., which may flow in a reverse direction yet include a completion at a bottom and a wellhead at a top), compressors (which cannot flow in reverse), etc. As an example, equipment with a profile direction may flow in an opposite direction and in the profile direction as a preference direction. As indicated in the example portion of a network 740 in FIG. 7, various types of arrows are indicated. As an example, other equipment may be directionless, for example, without a preference in terms of direction.

As an example, portions of a network may be characterized by types of building blocks. For example, a first building block may pertain to a branch having flow in one direction and, as such, the branch is strictly constrained in terms of one or more pieces of strict directional equipment included in that branch. Such equipment can therefore determine an extent of a branch. An example of a second building block can consider one or more physical branch terminations. For example, a physical branch termination may be via equipment, such as, equipment with more than two connections (e.g., junctions, separators or leaf equipment like wells, sources, sinks, etc.).

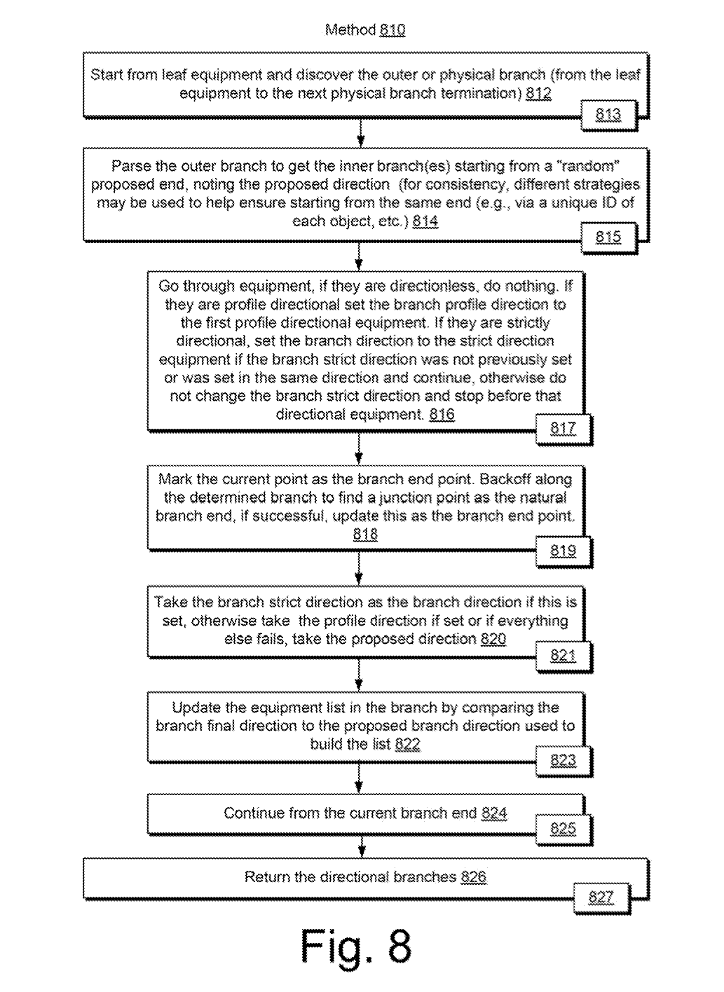

FIG. 8 shows an example of a method 810 that includes various blocks. As shown the method 810 includes: a start block 812 to start from leaf equipment and discover the outer or physical branch (from the leaf equipment to the next physical branch termination); a parse block 814 to parse the outer branch to get the inner branches starting from a proposed end (e.g., optionally a random proposed end), noting a proposed direction (e.g., for consistency, different strategies may be used to help ensure starting from the same end (for example the unique ID of each object, etc.)); an analysis block 816 to: (a) go through pieces of equipment where, if a piece of equipment is directionless, continue; (b) if a piece of equipment is profile directional, setting the branch profile direction to the first profile of the directional piece of equipment; and (c) if a piece of equipment is strictly directional, setting the branch direction to the strict direction of the piece of equipment if the branch strict direction was not previously set or was set in the same direction and continue, otherwise do not change the branch strict direction and stop before that piece of directional equipment; a mark block 818 to mark a current point as a branch end point and to back-off along a determined branch to find a junction point as a natural branch end and, if successful, to update this as the branch end point; a branch direction block 820 to take the branch strict direction as the branch direction if this is set, otherwise to take the profile direction if set or in the instance of failure of such approaches, to take the proposed direction; an update block 822 to update an equipment list in a branch by comparing the branch final direction to the proposed branch direction, for example, used to build the list; a continue block 824 to continue from the current branch end; and a return block 826 to return the directional branches.

The method 810 is shown in FIG. 8 in association with various computer-readable media (CRM) blocks 813, 815, 817, 819, 821, 823, 825 and 827. Such blocks generally include instructions suitable for execution by one or more processors (or processing cores) to instruct a computing device or system to perform one or more actions. While various blocks are shown, a single medium may be configured with instructions to allow for, at least in part, performance of various actions of the method 810. As an example, a computer-readable medium (CRM) may be a computer-readable storage medium that is a physical component (e.g., not a carrier wave).

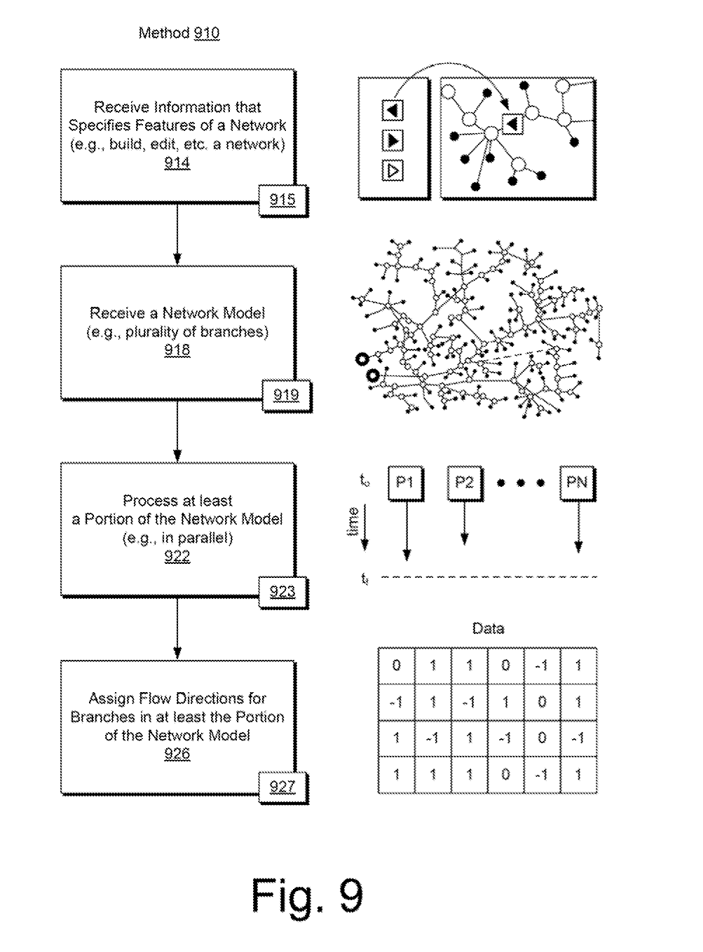

FIG. 9 shows an example of a method 910 that includes a reception block 914 for receiving information that specifies features of a network (e.g., to build, edit, etc. a model of a network), a reception block 918 for receiving a model of a network of a production system that includes information that specifies branches and pieces of equipment, a process block 922 for processing at least a portion of the information for at least a portion of the model of the network (e.g., in parallel), assessing a plurality of flow paths, and an assignment block 926 for assigning a flow direction to each of the branches in the at least a portion of the model of the network.

As an example, information as to branches may be stored in the form of one or more arrays in one or more information storage devices (e.g., memory, drives, etc.). As an example, individual branches of a network may include fields (e.g., in an array, a database, etc.) where a value in a respective field specifies a direction of an individual branch. As an example, information as to nodes may be stored in the form of one or more arrays in one or more information storage devices (e.g., memory, drives, etc.). As an example, individual nodes of a network may include fields (e.g., in an array, a database, etc.) where a value in a respective field specifies a direction of an individual node. As an example, a method may include assigning a flow direction to individual branches, to individual nodes, etc. in at least a portion of a model of a network. As an example, assigning a flow direction to a node may inherently assign a flow direction to a branch. As an example, assigning a flow direction to a branch may inherently assign a flow direction to a node. As an example, assigning a flow direction to a branch may be accomplished, for example, by assigning a flow direction to one or more nodes that may define the branch (e.g., be part of the branch).

The method 910 is shown in FIG. 9 in association with various computer-readable media (CRM) blocks 915, 919, 923, and 927. Such blocks generally include instructions suitable for execution by one or more processors (or processing cores) to instruct a computing device or system to perform one or more actions. While various blocks are shown, a single medium may be configured with instructions to allow for, at least in part, performance of various actions of the method 910. As an example, a computer-readable medium (CRM) may be a computer-readable storage medium that is a physical component (i.e., not a carrier wave).

As an example, a method may include assigning a flow path direction to branches in a model of a network. As an example, for a branch, a flow direction may not be known a priori where processing provides the flow direction for that branch. As an example, a flow path direction may be assigned prior to processing (e.g., prior to performing a simulation run). In such an example, processing may act to ensure that there conflicts are avoided with respect to flow direction. For example, processing may aim to guarantee that flow directions for portions of a model of a network avoid conflicts where flow directions for individual portions may be one of forward on a path (e.g., a flow path), reverse on a path (e.g., a flow path), or no flow on a path. As an example, a user may construct a model of a network using a GUI, etc. where a system may process at least a portion of the model of the network. In such an example, results from processing may reveal directions where, for example, such directions comport with specifications of equipment, etc. As an example, consider a piece of equipment being associated with a branch and being specified as directionless where a flow direction may be assigned via processing to be in a first direction or a second direction, which may not be known a priori.

As an example, a system may be configured to generalize editing of a network, for example, to flatten a network editing approach and a branch editing approach (e.g., for branches of the network) into a general editing approach, which may provide for editing (e.g., or building) a model of a network optionally without a user having to specify flow direction of an individual branch or branches a priori. In such an example, an assumption may be avoided as to “each branch has a single flow direction” in that certain types of equipment, conditions, etc. may result (e.g., via simulation) to assign a flow direction to a branch that may possible differ from what a user may believe to be the flow direction a priori. In such an example, a user may be alleviated of a task or tasks as to specifying a flow direction for an individual branch or branches. As an example, flow directions may be assigned a priori, optionally randomly or otherwise to initialize a simulation, where performing the simulation may generate simulation results that assign logical flow directions (e.g., flow directions based on simulation results).

As an example, a method can include splitting a model of a network into a number of branches a priori while guaranteeing unidirectional flow in individual branches (e.g., once a simulation is complete) and, for example, also preventing unwanted branch shutdown. Such an approach may also provide a consistent way of getting the same result for similar networks, for example, without dependence on how a user builds a network. As an example, a system may be configured to enable driving of a simulator, for example, via application commands that issue responsive to interactions with a given branch (e.g., or branches). As an example, a method may include serial processing, parallel processing and/or serial processing and parallel processing (e.g., offset in time, etc.).

As an example, a method may include assigning flow directions as part of initializing a simulation run where such flow directions may be assigned randomly or in another manner. For example, such a method may proceed without having a user explicitly specify flow directions; rather, a user may place equipment, build branches, etc. where a system specifies the equipment (e.g., as being one of unidirectional, bidirectional or directionless) and where the system processes the specified information to assign flow directions based on the processing (e.g., simulation).

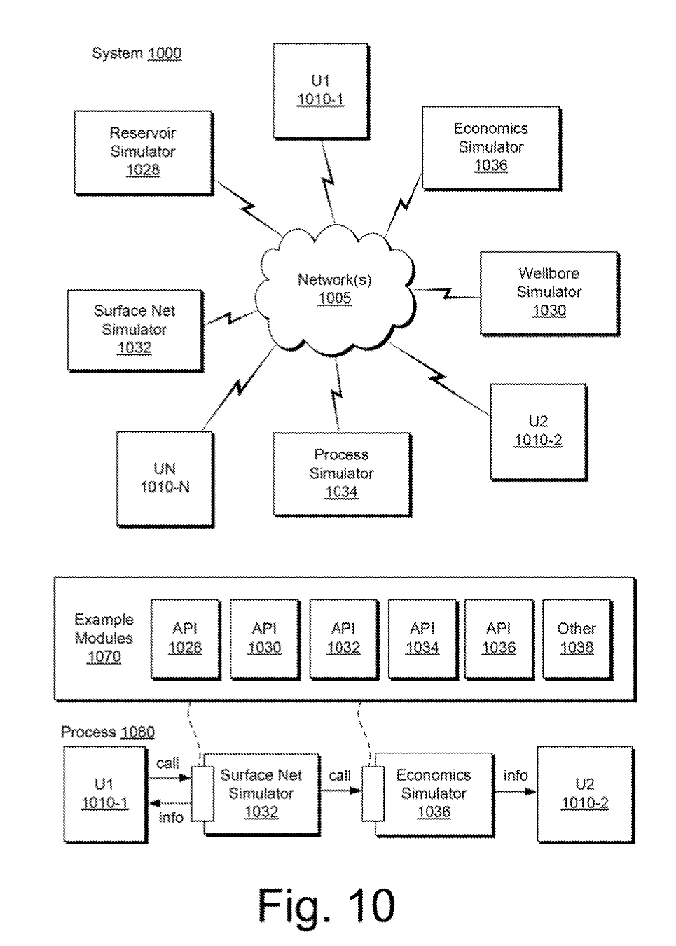

FIG. 10 shows an example of a system 1000, examples of modules 1070 and an example of a process 1080. As shown, the system 1000 may include one or more networks 1005, one or more users 1010-1, 1010-2 and 1010-N, a reservoir simulator 1028, a wellbore simulator 1030, a surface network simulator 1032, a process simulator 1034 and an economics simulator 1036 (see, e.g., FIG. 2). As an example, the surface network simulator 1032 may be configured to perform a method such as, for example, the method 910 of FIG. 9 or one or more portions of the method 910 of FIG. 9.

As an example, the system 1000 may include one or more modules 1070, which may include, for example, one or more application programming interfaces modules 1028, 1030, 1032, 1034, 1036 and/or one or more other modules 1038. As an example, various components of the system 1000 may be configured to receive and/or transmit information via implementation of one or more modules. In such an example, the one or more modules may include one or more API modules, which may include instructions for implementation of one or more APIs. As an example, an API may operate according to a specification. For example, a specification may specify a call that may result in a response. As an example, a call may include information where, upon receipt, at least a portion of the information is processed and, for example, where a result may be transmitted based at least in part on such processing (e.g., consider a call and response model).

In FIG. 10, the process 1080 may implement one or more APIs. For example, the user 1010-1 of the system 1000 may issue an API call to an API of the surface network simulator 1032. As indicated, the surface network simulator 1032 may perform a process based at least in part on the API call and transmit information to the user 1010-1 (e.g., to a computing device, etc. of the user 1010-1). As an example, the surface network simulator 1032 may issue an API call to the economics simulator 1036, which may be based at least in part on the API call from the user 1010-1 to the surface network simulator 1032. As an example, the economics simulator 1036 may transmit information to another user, for example, the user 1010-2 (e.g., to a computing device, etc., of the user 1010-2).

As an example, the process 1080 may allow a user to interact with a model of a network such that results stemming from one or more interactions are transmitted to one or more other portions of the system 1000 and optionally to one or more other users (e.g., a respective data store, computing device, etc. that may be associated with and/or accessible by a user, etc.). For example, consider the user 1010-1 building a model of a network, the simulator 1032 assigning flow directions to branches in the network and the simulator 1032 transmitting assigned flow direction information to the user 1010-1 and optionally to one or more other components.

As an example, a method can include receiving a model of a network of a production system that includes information that specifies branches and pieces of equipment; processing in parallel at least a portion of the information for at least a portion of the model of the network; and, based at least in part on the processing, assigning a flow direction to each of the branches in the at least a portion of the model of the network. In such an example, the pieces of equipment may include at least one piece of equipment that has a strict direction (e.g., unidirectional), at least one piece of equipment that is bidirectional and/or at least one piece of equipment that is directionless.

As an example, a method may include processing, optionally in parallel, which includes specifying a random flow direction for each of a plurality of branches in at least a portion of a model of a network.

As an example, a method may include processing, optionally in parallel, which includes assessing at least one of a plurality of branches from a branch end point that includes a terminal piece of equipment and/or from an internal branch point.

As an example, a method may include processing, optionally in parallel, which includes directionally assessing individual branches from respective branch points, encountering a piece of equipment in one of the individual branches, and assigning a flow direction to the one of the individual branches based at least in part on a directionality of the piece of equipment. In such an example, the method may further include encountering another piece of equipment in the one of the individual branches where the another piece of equipment includes a flow direction opposite to the assigned flow direction of the branch and assigning a stop branch point to the branch based at least in part on a location of the another piece of equipment.

As an example, a method may include processing, optionally in parallel, which includes directionally assessing individual branches from respective branch points, encountering a flowline in one of the individual branches, and assigning a flow direction to the one of the individual branches based at least in part on a profile direction of the flowline.

As an example, a method may include processing, optionally in parallel, which includes directionally assessing individual branches from respective branch points where each of the branch points includes an identifier. In such an example, each of the branch points may include a node of a model of a network where each of the identifiers may be or include a node ID.

As an example, a method may include processing in parallel that divides at least a portion of a model of a network into individual branches. In such an example, the method may include assigning a flow direction to each of the branches in the at least a portion of the model of the network in a manner that guarantees a single flow direction for each of the branches.

As an example, a method may include rendering to a display a graphical representation of at least a portion of a model of a network where the graphical representation includes flow direction information (e.g., via one or more of colors, arrows, etc.).

As an example, a system can include a processor memory accessible by the processor; one or more modules stored in the memory where the one or more modules include processor-executable instructions to instruct the system to receive a model of a network of a production system that includes information that specifies branches and pieces of equipment; process in parallel at least a portion of the information for at least a portion of the model of the network; and, based at least in part on the process in parallel, assign a flow direction to each of the branches in the at least a portion of the model of the network. In such an example, the system may include an interface configured to receive information that specifies at least a location of a piece of equipment with respect to the model of the network. As an example, a system may include an interface configured to transmit information for rendering a graphical representation of at least a portion of a model of a network.

As an example, one or more computer-readable storage media can include computer-executable instructions executable by a computer to instruct the computer to: process in parallel at least a portion of information that specifies branches and pieces of equipment for at least a portion of a model of a network; and, based at least in part on the process in parallel, assign a flow direction to each of the branches in the at least a portion of the model of the network. In such example, the one or more computer-readable storage media may include computer-executable instructions to instruct the computer to receive information that specifies at least a location of a piece of equipment with respect to the model of the network. As an example, one or more computer-readable storage media may include computer-executable instructions to instruct the computer to render a graphical representation of at least a portion of a model of a network.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

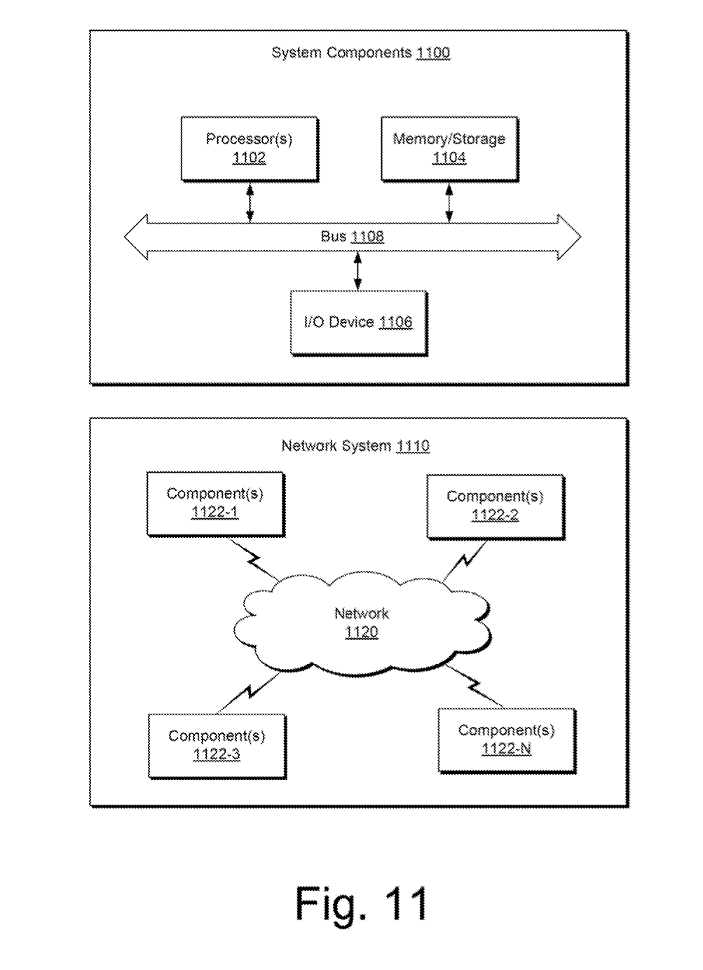

FIG. 11 shows components of an example of a computing system 1100 and an example of a networked system 1110. The system 1100 includes one or more processors 1102, memory and/or storage components 1104, one or more input and/or output devices 1106 and a bus 1108. In an example embodiment, instructions may be stored in one or more computer-readable media (e.g., memory/storage components 1104). Such instructions may be read by one or more processors (e.g., the processor(s) 1102) via a communication bus (e.g., the bus 1108), which may be wired or wireless. The one or more processors may execute such instructions to implement (wholly or in part) one or more attributes (e.g., as part of a method). A user may view output from and interact with a process via an I/O device (e.g., the device 1106). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 1110. The network system 1110 includes components 1122-1, 1122-2, 1122-3, . . . , 1122-N. For example, the components 1122-1 may include the processor(s) 1102 while the component(s) 1122-3 may include memory accessible by the processor(s) 1102. Further, the component(s) 1102-2 may include an I/O device for display and optionally interaction with a method. The network may be or include the Internet, an intranet, a cellular network, a satellite network, etc.

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words “means for” together with an associated function.

What is claimed is:

1. A method comprising:
receiving a model of a network of a production system that comprises information that specifies branches and pieces of equipment;
processing in parallel at least a portion of the information for at least a portion of the model of the network; and
based at least in part on the processing, assigning a flow direction to each of the branches in the at least a portion of the model of the network.

2. The method of claim 1 wherein the pieces of equipment comprise at least one piece of equipment that comprises a strict direction.

3. The method of claim 1 wherein the pieces of equipment comprise at least one piece of equipment that is bidirectional.

4. The method of claim 1 wherein the pieces of equipment comprise at least one piece of equipment that is directionless.

5. The method of claim 1 wherein the processing in parallel comprises specifying a random flow direction for each of the branches in the at least a portion of the model of the network.

6. The method of claim 1 wherein the processing in parallel comprises, based at least in part on the at least a portion of the information, assessing at least one of the branches from a branch end point that comprises a terminal piece of equipment.

7. The method of claim 1 wherein the processing in parallel comprises, based at least in part on the at least a portion of the information, assessing at least one of the branches from an internal branch point.

8. The method of claim 1 wherein the processing in parallel comprises, based at least in part on the at least a portion of the information, directionally assessing individual branches from respective branch points, encountering a piece of equipment in one of the individual branches, and assigning a flow direction to the one of the individual branches based at least in part on a directionality of the piece of equipment.

9. The method of claim 8 further comprising encountering another piece of equipment in the one of the individual branches wherein the another piece of equipment comprises a flow direction opposite to the assigned flow direction of the branch and assigning a stop branch point to the branch based at least in part on a location of the another piece of equipment.

10. The method of claim 1 wherein the processing in parallel comprises, based at least in part on the at least a portion of the information, directionally assessing individual branches from respective branch points, encountering a flowline in one of the individual branches, and assigning a flow direction to the one of the individual branches based at least in part on a profile direction of the flowline.

11. The method of claim 1 wherein the processing in parallel comprises, based at least in part on the at least a portion of the information, directionally assessing individual branches from respective branch points wherein each of the branch points comprises an identifier.

12. The method of claim 11 wherein each of the branch points comprises a node of the model of the network and wherein each of the identifiers comprises a node ID.

13. The method of claim 1 wherein the processing in parallel divides the at least a portion of the model of the network into individual branches and wherein the assigning a flow direction to each of the branches in the at least a portion of the model of the network guarantees a single flow direction for each of the branches.

14. The method of claim 1 further comprising rendering to a display a graphical representation of at least a portion of the model of the network wherein the graphical representation comprises flow direction information.

15. A system comprising:
a processor;
memory accessible by the processor;
one or more modules stored in the memory wherein the one or more modules comprises processor-executable instructions to instruct the system to
receive a model of a network of a production system that comprises information that specifies branches and pieces of equipment;
process in parallel at least a portion of the information for at least a portion of the model of the network; and
based at least in part on the process in parallel, assign a flow direction to each of the branches in the at least a portion of the model of the network.

16. The system of claim 15 further comprising an interface configured to receive information that specifies at least a location of a piece of equipment with respect to the model of the network.

17. The system of claim 15 further comprising an interface configured to transmit information for rendering a graphical representation of at least a portion of the model of the network.

18. One or more computer-readable storage media comprising computer-executable instructions executable by a computer to instruct the computer to:
process in parallel at least a portion of information that specifies branches and pieces of equipment for at least a portion of a model of a network; and
based at least in part on the process in parallel, assign a flow direction to each of the branches in the at least a portion of the model of the network.

19. The one or more computer-readable storage media of claim 18 further comprising computer-executable instructions to instruct the computer to receive information that specifies at least a location of a piece of equipment with respect to the model of the network.

20. The one or more computer-readable storage media of claim 18 further comprising computer-executable instructions to instruct the computer to render a graphical representation of at least a portion of the model of the network.
